(19) United States
(12) Patent Application Publication
(10) Pub. No.: US 2008/0151831 A1
(43) Pub. Date: Jun. 26, 2008

(54) Orthogonal repetition and hybrid ARQ scheme

(76) Inventors: Farooq Khan, Allen, TX (US); Cornelius Van Rensburg, Dallas, TX (US); Zhouyue Pi, Richardson, TX (US); Jiann-An Tsai, Plano, TX (US); Yinong Ding, Plano, TX (US)

Correspondence Address: Robert E. Bushnell, Suite 300, 1522 K Street, N.W., Washington, DC, 20005, US

(21) Appl. No.: 11/806,660

(22) Filed: Jun. 1, 2007

Related U.S. Application Data
(60) Provisional application No. 60/876,935, filed on Dec. 22, 2006.

(51) Int. Cl. H04Q 7/30

(52) U.S. Cl. 370/330; 375/260

(57) ABSTRACT

A multi-user, multiple input, multiple output network and process for transmitting data in a communication system encompassing multiple users, contemplates the steps of: a first user transmitting a first transmission frame to a base transceiver station while a second user simultaneously transmits a third transmission frame to the base station; the first and second users simultaneously transmit a second transmission frame and a fourth transmission frames respectively to the base station, with the second transmission frame being an orthogonally spread version of the first transmission frame, and the fourth transmission frame being an orthogonally spread version of the second transmission frame.

### PRIORITY

This application makes reference to, claims all benefits inuring under 35 U.S.C. §119 and 120 from, and incorporates herein a provisional application filed in the U.S. Patent & Trademark Office on the 22 Dec. 2006, and there duly assigned Ser. No. 60/876,935.

### BACKGROUND OF THE INVENTION

The present invention relates generally an orthogonal repetition and hybrid Automatic Repeat-reQuest (ARQ) scheme where repeated signals, from multiple users transmitting simultaneously using the same time-frequency resource, are spread using orthogonal functions such as a Fourier function or a Hadamard function in a multiple input and multiple output (MIMO) system.

### DESCRIPTION OF THE RELATED ART

During data transmission, especially wireless data transmission, error inevitably occurs to decrease the quality of the transmitted data. Therefore, the data is retransmitted in order to correct the error.

Automatic Repeat-reQuest (ARQ) is an error control method for data transmission which makes use of acknowledgments and timeouts to achieve reliable data transmission. An acknowledgment is a message sent by the receiver to the transmitter to indicate that it has correctly received a data frame.

Usually, when the transmitter does not receive the acknowledgment before the timeout occurs (i.e. within a reasonable amount of time after sending the data frame), it retransmits the frame until the data within the frame is either correctly received or the error persists beyond a predetermined number of re-transmissions.

Hybrid ARQ (HARQ), is a variation of the ARQ error control method, which gives better performance than the ordinary ARQ scheme, particularly over wireless channels, at the cost of increased implementation complexity. One version HARQ is described in the IEEE 802.16e standard.

The simplest version of HARQ is Type I HARQ which simply combines forward error correction (FEC) and ARQ by encoding the data block plus error-detection information (such as cyclic redundancy check (CRC)) with an error-correction code (such as a Reed-Solomon code or a Turbo code) prior to transmission. When the coded data block is received, the receiver first decodes the error-correction code. If the channel quality is good enough, all transmission errors should be correctable, and the receiver can obtain the correct data block. If the channel quality is bad and not all transmission errors can be corrected, the receiver will detect this situation using the error-detection code, then the received coded data block is discarded and a re-transmission is requested by the receiver, similar to ARQ.

In practice, the incorrectly received coded data blocks are often stored at the receiver rather than discarded, and when the retransmitted coded data block is received, the information from both coded data blocks are combined (as by Chase combining) before being fed to the decoder of the error-correction code, which can increase the probability of successful decoding. To further improve performance, Type II/III HARQ, or incremental redundancy HARQ, has also been proposed. In this scheme, different re-transmissions are coded differently rather than simply repeating the same coded bits as in Chase combining, which gives a somewhat better performance since coding is effectively done across re-transmissions. The difference between type III HARQ and type II HARQ is that the re-transmission packets in Type III HARQ may be decoded by themselves.

An example of incremental redundancy HARQ is High-Speed Downlink Packet Access (HSDPA) (sometimes known as High-Speed Downlink Protocol Access), a 3G mobile telephony protocol, wherein the data block is first coded with a punctured ⅓ Turbo code, then during each re-transmission the coded block is (usually) punctured further (i.e., only a fraction of the coded bits are chosen) and sent. The punctuation pattern used during each re-transmission can be different; therefore different coded bits can be sent at each time.

HARQ can be used in a stop-and-wait mode or in a selective repeat mode. Stop-and-wait is simpler, but the need to wait for the receiver's acknowledgment reduces efficiency, thus multiple stop-and-wait HARQ processes are often done in parallel in practice: when one HARQ process is waiting for an acknowledgment, another process can use the channel to send some more data.

When HARQ is applied in MIMO (Multiple Input Multiple Output) scenarios, there is a possibility that the data blocks transmitted through different inputs might interfere with each other during the transmission. Therefore, it is necessary to encode the data blocks before transmission.

Recently a single user Alamouti-HARQ scheme has been proposed. This scheme may be difficult, however, to apply to multi-user MIMO (Multiple Input Multiple Output) scenarios.

Generally, these efforts are unsuitable for MIMO (Multiple Input Multiple Output) scenarios for multiple, simultaneous transmissions because these efforts are still plagued with difficulties in decoding even after a re-transmission, and with non-coherent noise.

### SUMMARY OF THE INVENTION

It is therefore an object of the present invention to provide an improved hybrid automatic repeat-request scheme, and improved transmitters and receivers incorporating this automatic repeat-request scheme.

It is another object to provide an orthogonal repetition and hybrid automatic repeat-request scheme for multiple user, multiple input and multiple output communication system and transmitters and receivers implementing the scheme.

According to the present invention, there is provided a multiple user, multiple input and multiple output communication network, including a base station disposed to communicate via the plurality of antennas with a plurality of subscriber stations by scheduling a first subscriber station and a second subscriber station to transmit in an uplink to the base station in common time and frequency slots. The base station schedules the first subscriber station to transmit a first symbol representing a first packet of user data in a first of the time and frequency slots, while the second subscriber station is scheduled to transmit a second symbol representing a second packet of user data in the first of the time and frequency slots. In addition, the base station schedules the first subscriber station to transmit a third symbol that is an orthogonally spread version of the first symbol in a second of the time and frequency slots, while the second subscriber station transmits a fourth symbol that is an orthogonally spread version of the second symbol in the second of the time and frequency slots. A relation exists between the orthogonal spread of the third symbol and the orthogonal spread of the fourth symbol.

In addition, the base station may instruct the first and second subscriber stations to generate the third symbol and the fourth symbol by modulating the first and second symbols according to a Fourier matrix or a Hadamard matrix.

Each element of the Fourier matrix may be established by:

$${P}_{mn} = {e}^{j2π m ( n + \frac{g}{G} )}$$

$$m , n = 0 , 1 , … ( N - 1 ) ,$$

where N is the dimension of the Fourier matrix and G is the total number of matrices generated, m is the row number of the element, n is the column number of the element, and g is selected to be any number between 0 and G−1. N may be selected to equal the number of the subscriber stations simultaneously instructed by the base station to make transmissions within the same time and frequency slot.

According to the present invention, there is provided a method for a base station communicated with a plurality of subscriber stations in common time and frequency slots, to instruct the transmission of information by the subscriber stations, the method includes the steps of: scheduling the first subscriber station to transmit a first symbol representing a first packet of user data in a first of said time and frequency slots, while scheduling the second subscriber station to transmit a second symbol representing a second packet of user data in said first of said time and frequency slots, and scheduling the first subscriber station to transmit a third symbol that is an orthogonally spread version of the first symbol in a second of said time and frequency slots, while scheduling the second subscriber station to transmit a fourth symbol that is an orthogonally spread version of the second symbol in the second of said time and frequency slots, with a relation existing between the orthogonal spread of the third symbol and the orthogonal spread of the fourth symbol.

According to the present invention, there is provided a wireless network, including a base station disposed to communicate with a subscriber station by scheduling simultaneous transmission in an uplink to the base station in common time and frequency slots. The base station schedules the subscriber station to transmit a first symbol representing a first packet of data during a first of said time and frequency slots, while the base station schedules the subscriber station to transmit a second symbol representing a second packet of data during said first of said time and frequency slots. In addition, the base station schedules the subscriber station to transmit a third symbol that is an orthogonally spread version of the first symbol in a second of said time and frequency slots, while the base station schedules the subscriber station to transmit a fourth symbol that is an orthogonally spread version of the second symbol during the second of said time and frequency slots. A relation exists between the orthogonal spread of the third symbol and the orthogonal spread of the fourth symbol.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of an exemplar of a transmitter and a receiver for data transmission and reception using orthogonal frequency division multiplexing;

FIG. 2 is a block diagram of a transmitter and a receiver for a discreet Fourier transform spread orthogonal frequency division multiplexing system;

FIG. 3 is a block diagram showing a simplified exemplar of a 4×4 multiple input multiple output scheme of communication between a transmitter and a receiver;

FIG. 4 is a block diagram showing a single-code word, multiple input multiple output scheme;

FIG. 5 is a block diagram showing a multi-code word, multiple input multiple output scheme;

FIG. 6 is a block diagram showing generation of subpackets in a hybrid automatic re-transmission request scheme;

FIG. 7 shows an exemplar of a hybrid automatic re-transmission request scheme as applied in a wireless communication system;

FIG. 8 shows an Alamouti-hybrid automatic re-transmission request scheme as used in contemporary designs;

FIG. 9 shows an exemplar of an uplink multi-user multiple input multiple output system;

FIG. 10 illustrates the combination of repeated transmission of symbols by two users;

FIG. 11 shows the combination of repeated transmission of symbols by two users without change of channels across repeated transmission;

FIG. 12A is a block diagram of two user equipment for transmitting signals as the first embodiment according to the principles of the current invention;

FIG. 12B is a block diagrams of a base station for receiving signals as the first embodiment according to the principles of the current invention;

FIG. 12C shows transmission of signals to cancel interference between the signals as the first embodiment according to the principles of the current invention;

FIG. 13A is a block diagram of a user equipment for transmitting two data streams as the second embodiment according to the principles of the current invention;

FIG. 13B illustrates the principle of interference cancellation in multiple data streams transmitted to the same user as the second embodiment according to the principles of the current invention;

FIG. 14 shows in a third embodiment of the current invention, repeated symbols in a 4-stream multiple input multiple output system are modulated using a single 4×4 matrix;

FIG. 15 shows in a fourth embodiment of the principles of the current invention, repeated symbols in a 4-stream multiple input multiple output system are modulated using two 2×2 Fourier matrices;

FIG. 16 illustrates in a fifth embodiment of the principles of the current invention, repeated symbols in a 4-stream multiple input multiple output system are modulated using a 4×4 Hadamard matrix;

FIG. 17 illustrates in a sixth embodiment of the principles of the current invention, repeated symbols from four users are modulated using two 2×2 matrices;

FIG. 18 illustrates in seventh embodiment of the principles of the current invention, different Fourier matrices are used for modulating different symbols transmitted by different users in neighboring cells;

FIG. 19 illustrates a use of different Fourier matrices for different symbols transmitted by two users in each of the three neighboring cells according to the seventh embodiment of the principles of the current invention;

FIG. 20 illustrates in an eighth embodiment of the principles of the current invention, the use of different Fourier matrices in different sectors of a base station; and

FIG. 21 illustrates in a ninth embodiment of the principles of the current invention, signaling of a matrix column used for transmission from two users.

### DETAILED DESCRIPTION OF THE INVENTION

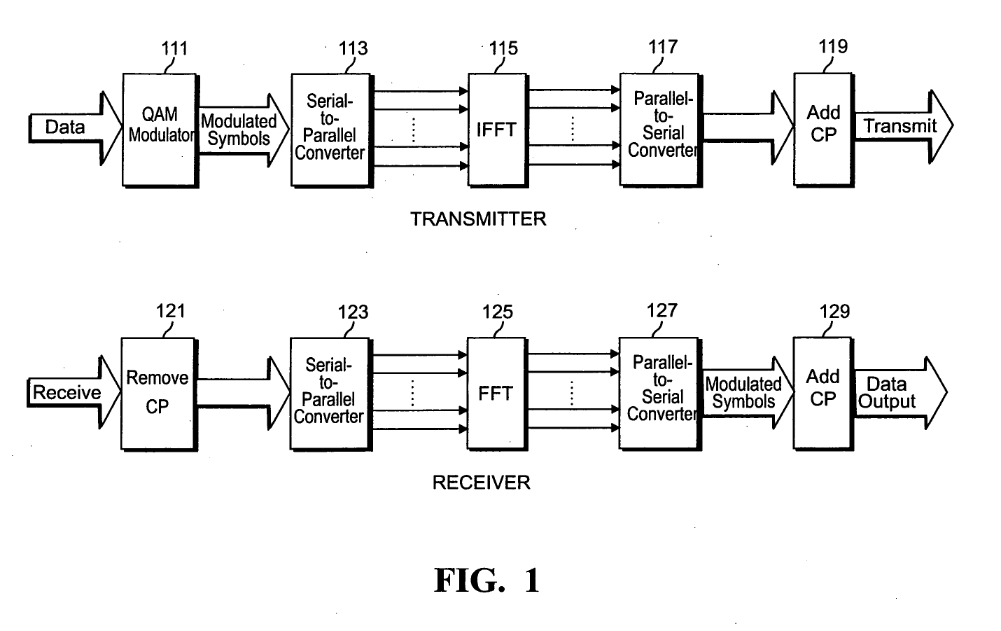

A simplified example of data transmission/reception using Orthogonal Frequency Division Multiplexing (OFDM) is shown in FIG. 1. The data to be transmitted is modulated by a quadrature amplitude modulation (QAM) modulator 111. The QAM modulated symbols are serial-to-parallel converted by a serial-to-parallel convertor 113 and input to an inverse fast Fourier transform (IFFT) unit 115. At the output of IFFT unit 115, the N time-domain samples are obtained. Here N refers to the sampling number of IFFT/FFT used by the OFDM system. The signal from IFFT unit 115 is parallel-to-serial converted by a parallel-to-serial convertor 117 and a cyclic prefix (CP) is added to the signal sequence. The resulting sequence of samples is referred to as OFDM symbol. At the receiver, the cyclic prefix is first removed and the signal is serial-to-parallel converted before feeding the converted parallel signal into fast Fourier transform (FFT) transformer 125. The output of the FFT is parallel-to-serial converted and the resulting QAM modulation symbols are input to the QAM demodulator.

A discrete Fourier transform (DFT) spread (DFT-spread) OFDM system is attractive for uplink, i.e., for transmitting signals from a mobile station to a base station of a wireless system, due to its low peak-to-average power (PAPR) characteristic. This is due to limited transmission power available in a mobile station. A low PAPR enables a lower power amplifier back off and allows mobile equipment to transmit at a higher power and higher data rate, thereby improving the coverage and spectral efficiency of a wireless system.

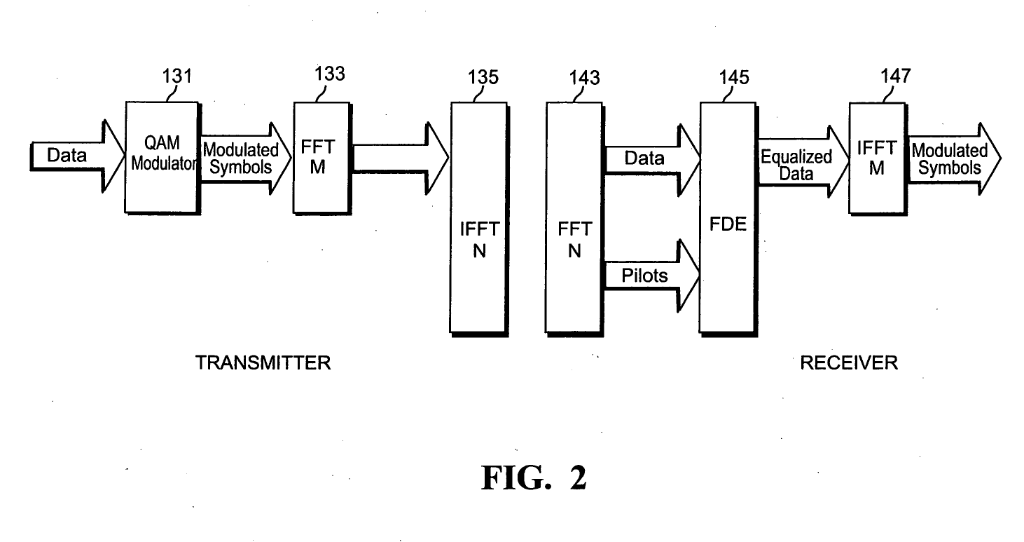

In a DFT-spread OFDM system, the data to be transmitted is first modulated by a QAM Modulator 131. The QAM modulated symbols are FFT-pre-coded by a FFT unit 133 before mapping into IFFT unit 135 as shown in FIG. 2. The subsequent signal processing is similar to the transmitter in the example as shown in FIG. 1, and thus the explanation thereof is omitted. At the receiver, the received signal is processed similarly as in the receiver shown in FIG. 1 until the FFT operation by FFT unit 143. Frequency-domain equalization (FDE) is performed by a FDE unit 145 after the FFT operation. An IFFT operation is then performed by IFFT unit 147 on the equalized symbols in order to obtain the data modulation symbols.

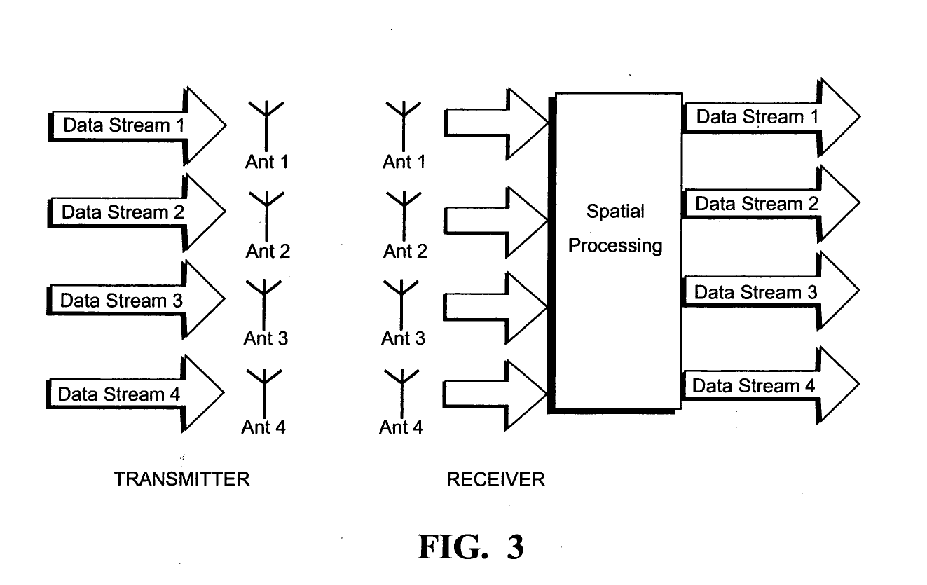

Multiple Input Multiple Output (MIMO) schemes use multiple transmit antennas and multiple receive antennas to improve the capacity and reliability of a wireless communication channel. A MIMO system promises linear increase in capacity with K where K is the minimum of number of transmit (M) and receive antennas (N), i.e. K=min(M,N). A simplified example of a 4×4 MIMO system is shown in FIG. 3.

In this example, four different data streams are transmitted separately from the four transmit antennas. The transmitted signals are received at the four receive antennas. Some form of spatial signal processing is performed on the received signals in order to recover the four data streams. An example of spatial signal processing is vertical Bell Laboratories Layered Space-Time (V-BLAST) which uses the successive interference cancellation principle to recover the transmitted data streams. Other variants of MIMO schemes include schemes that perform some kind of space-time coding across the transmit antennas (e.g., diagonal Bell Laboratories Layered Space-Time (D-BLAST)) and also beamforming schemes such as Spatial Division multiple Access (SDMA).

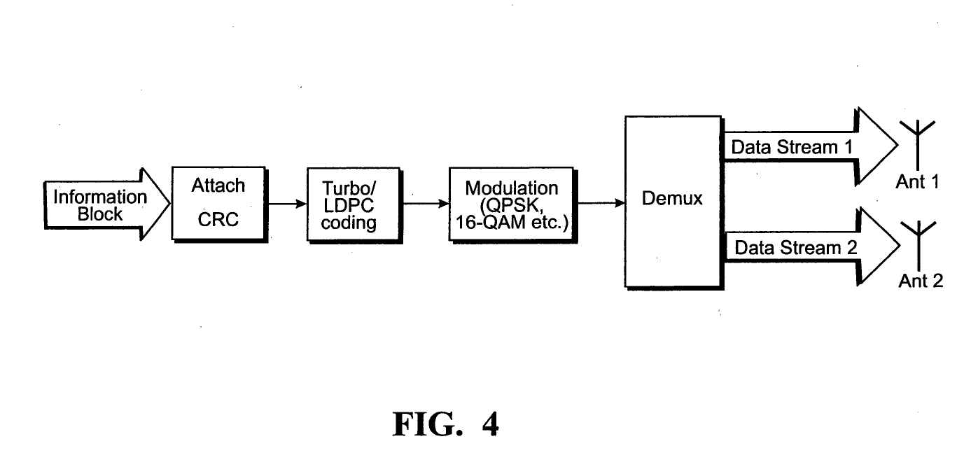

An example of single-code word MIMO scheme is given in FIG. 4. In case of single-code word MIMO transmission, a cyclic redundancy check (CRC) is added to a single information block and then coding, for example, using turbo codes and low-density parity check (LDPC) code, and modulation, for example, by quadrature phase-shift keying (QPSK) modulation scheme, are performed. The coded and modulated symbols are then demultiplexed for transmission over multiple antennas.

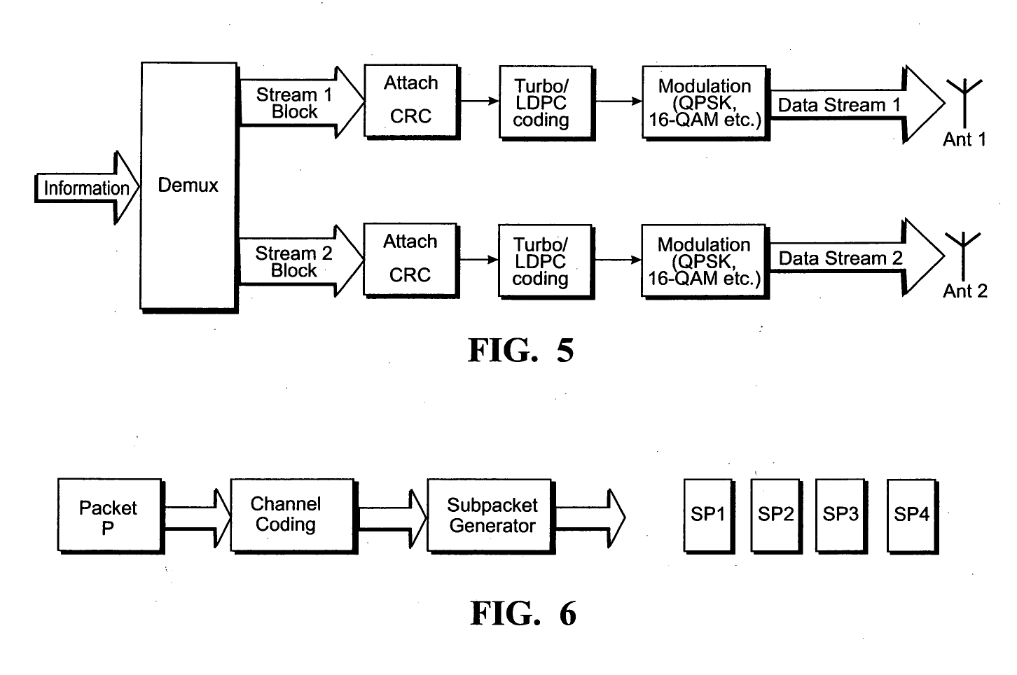

On the other hand, in case of multiple-code word MIMO transmission, shown in FIG. 5, the information block is demultiplexed into smaller information blocks. Individual CRCs are attached to these smaller information blocks and then separate coding and modulation are performed on these smaller blocks. These smaller information blocks are then transmitted through separate MIMO antennas or beams. It should be noted that in case of multi-code word MIMO transmissions, different modulation and coding can be used on each of the individual streams. Also, multi-code word transmission allows for more efficient post-decoding interference cancellation because, a CRC check can be performed on each of the code words before the code word is cancelled from the overall signal. In this way, only correctly received code words are cancelled, thereby avoiding any interference propagation in the cancellation process.

Hybrid automatic repeat request (ARQ) is a re-transmission scheme whereby the transmitter sends redundant coded information in small increments. The subpackets are generated at the transmitter by first performing channel coding on the information packet and then breaking the resulting coded bit stream into smaller units called subpackets as shown in FIG. 6. The hybrid ARQ re-transmissions can either contain redundant symbols or coded bits which are different than the previous transmission(s), or copies of the same symbols or coded bits as in the previous transmission(s). The scheme which retransmits copies of the same information is referred to as chase combining, while the scheme where retransmitted symbols or coded bits are different than the previous transmission is generally referred to as an incremental redundancy scheme. In case of chase combining, the subpackets SP1, SP2, SP3 and SP4 as shown in FIG. 6 are all identical.

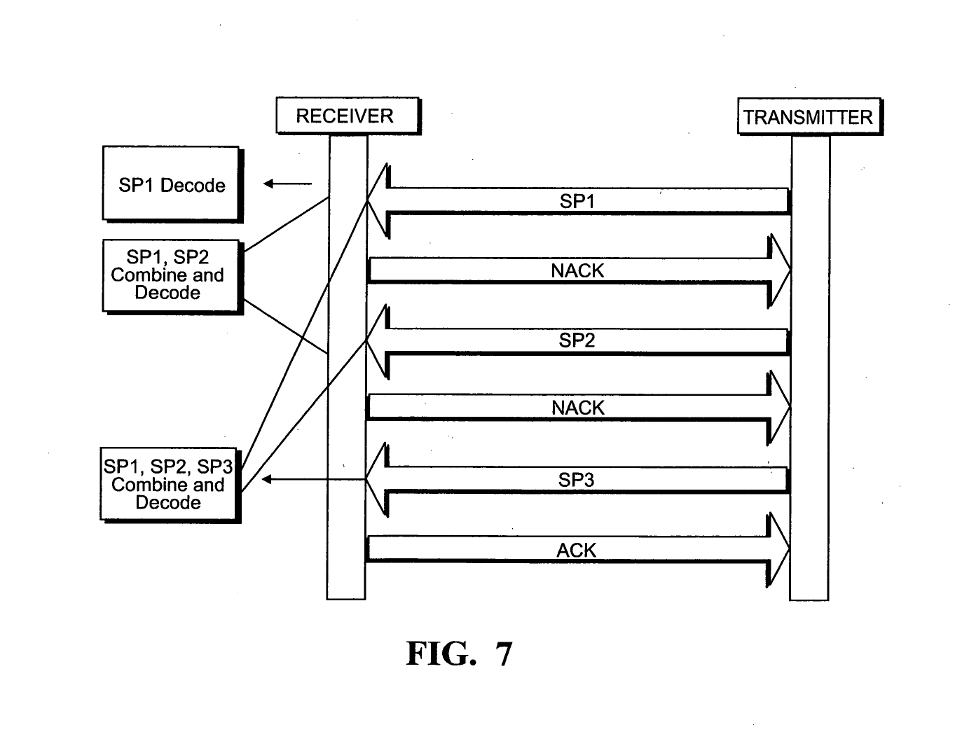

An example of Hybrid ARQ protocol is shown in FIG. 7. The receiver tries to decode the information after receiving the first subpacket SP1. In case of unsuccessful decoding, the receiver stores the SP1 and sends a negative acknowledgment (NACK) signal to the transmitter. After receiving the NACK signal, the transmitter performs transmission of the second subpacket SP2. After receiving the second subpacket, the receiver combines SP2 with the previously stored subpacket SP1 and tries to jointly decode the information packet P. At any point, if the information packet is successfully decoded by, for example, indication of a successful cyclic redundancy check (CRC), the receiver sends an acknowledgment (ACK) signal to the transmitter. In the example of FIG. 7, the information packet is successfully decoded after receiving and combining three subpackets, SP1, SP2 and SP3. The ARQ protocol shown in FIG. 7 is generally referred to as stop-and-wait protocol because the transmitter waits for the ACK/NACK signal before sending the next subpacket. After receiving the ACK signal, transmitter can move on to transmit a new information packet to the same or a different user.

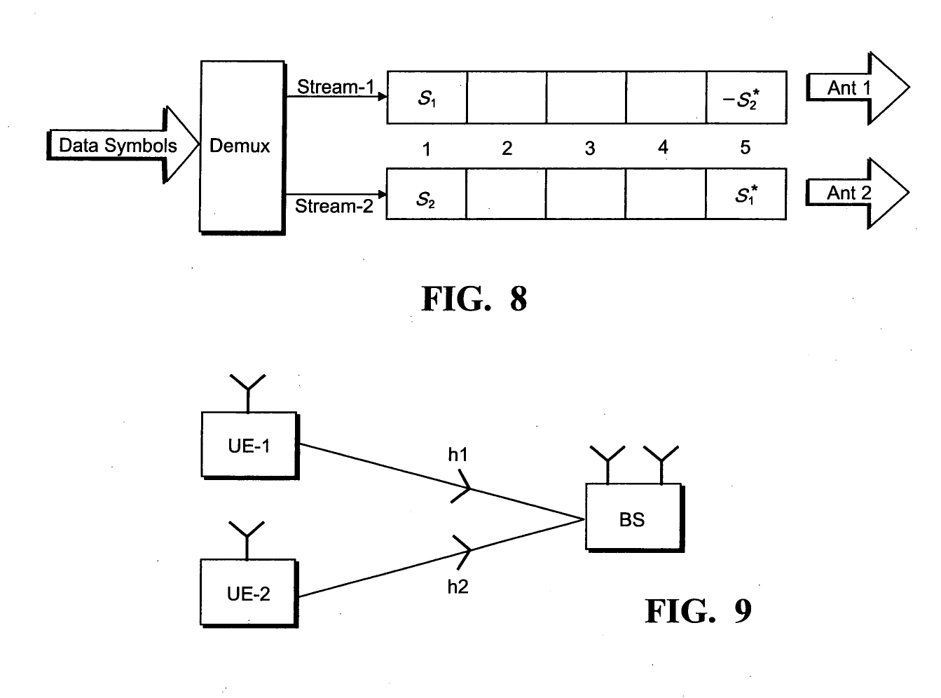

An example of Alamouti-Hybrid ARQ scheme proposed in the prior art is shown in FIG. 8. At time t1, complex modulated symbols S₁ and S₂ are transmitted from antenna-1 and antenna-2 respectively. In case of hybrid ARQ re-transmission at time t2, the symbols −S₂* and −S₁* are transmitted from antenna-1 and antenna-2 respectively. In the notation used here, A* denote complex conjugate of a complex number A. In case that the channel does not change between time t1 and t2, symbols S₁ and S₂ are received in an orthogonal fashion with each symbol experiencing no interference from the other symbol.

The problem with the Alamouti-HARQ scheme is that the Alamouti-HARQ scheme can only be applied to a single user uplink, i.e., transmitting signal from a single mobile station to a base station, or a single user downlink, i.e., transmitting signals from a base station to a single mobile station. The Alamouti-HARQ scheme, however, cannot be applied to uplink or downlink in multi-user MIMO scenario. For example, at time 2, user 1 can not transmit a complex conjugate of the signal generated by user 2 since user 1 does not have information regarding the signal transmitted by user 2. Also, the scheme cannot be applied to uplink transmissions where each user is transmitting a single stream to a base station. In the outline below, the uplink multi-user multiple access encounters a problem when the users perform transmissions using the same resources. This situation can occur in practice when uplink multi-user MIMO is supported or when a base station schedules multiple users using the same time-frequency resource and employ successive interference cancellation techniques to cancel inter-user interference.

An example of uplink multi-user MIMO communications is shown in FIG. 9. In this example, base station can schedule two units of user equipment (UEs) or mobile subscriber stations on the same time-frequency resource. The base station can use a Linear minimum mean error (LMMSE) algorithm to separate the signals from the two users. Moreover, a successive interference cancellation (SIC) can be used to cancel the signal of the firstly decoded user before proceeding with decoding of second user's signal.

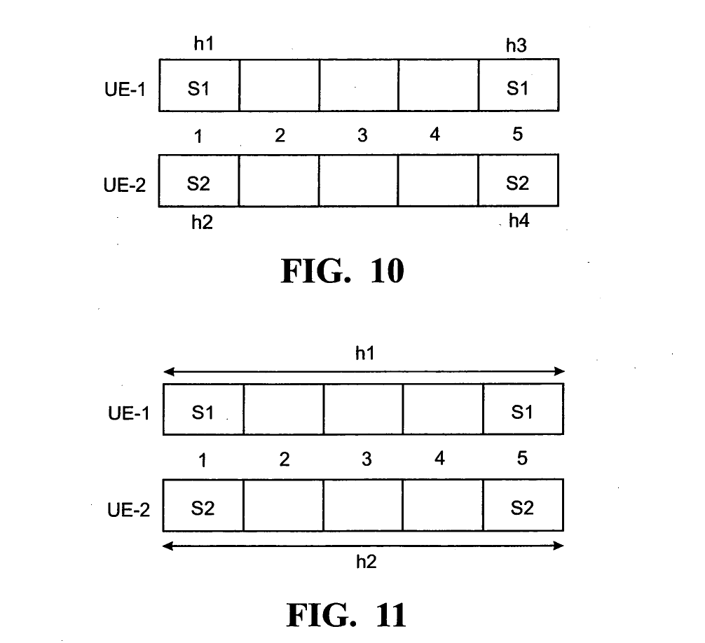

Assuming two users UE-1 and UE-2 transmit symbols s₁ and s₂ respectively in time slot 1 as shown in FIG. 10 to a base station. Also assume that both users use the same time-frequency resource and therefore their transmissions interfere with each other. Moreover, both users repeat transmission of the same symbols in time slot 5. Received signals r₁ and r₂ at the base station in time slot 1 and time slot 2, respectively, can be written as.

r₁=h₁s₁+h₂s₂+n₁

r₂=h₃s₁+h₄s₂+n₂ (1)

where h₁ and h₃ are channel gains between UE-1 and the base station in time slots 1 and 5, respectively, h₂ and h₄ are channel gains between UE-2 and the base station in time slots 1 and 5, respectively, and n₁ and n₂ represent additive white Gaussian noise (AWGN) in time slots 1 and 5, respectively. The base station performs equalization on received signals r₁ and r₂ and combines the two received signals to recover the signals ŝ₁ and ŝ₂ for each unit of the user equipment as below:

$$\begin{matrix}{\hat{s}}_{1} = {h}_{1}^{*} ( {h}_{1} {s}_{1} + {h}_{2} {s}_{2} + {n}_{1} ) + {h}_{3}^{*} ( {h}_{3} {s}_{1} + {h}_{4} {s}_{2} + {n}_{2} ) \\ = ( {\vert {h}_{1} \vert}^{2} + {\vert {h}_{3} \vert}^{2} ) {s}_{1} + ( {h}_{1}^{*} {h}_{2} + {h}_{3}^{*} {h}_{4} ) {s}_{2} + {h}_{1}^{*} {n}_{1} + {h}_{3}^{*} {n}_{2}\end{matrix} \\ \begin{matrix}{\hat{s}}_{2} = {h}_{2}^{*} ( {h}_{1} {s}_{1} + {h}_{2} {s}_{2} + {n}_{1} ) + {h}_{4}^{*} ( {h}_{3} {s}_{1} + {h}_{4} {s}_{2} + {n}_{2} ) \\ = ( {\vert {h}_{2} \vert}^{2} + {\vert {h}_{4} \vert}^{2} ) {s}_{2} + ( {h}_{2}^{*} {h}_{1} + {h}_{4}^{*} {h}_{3} ) {s}_{1} + ( {h}_{2}^{*} {n}_{1} + {h}_{4}^{*} {n}_{2} )\end{matrix} \qquad ( 2 )$$

It can be seen that when h₁ is independent of h₃ and h₂ independent of h₄, at either unit of the user equipment, the desired signals combine coherently while the interference from the other signal and noise combine non-coherently, i.e., out of phase. For example, in the estimated signal ŝ₁ for UE-1, the interference signal received in time slot 1, i.e., h₁*h₂s₂, and the interference signal received in time slot 5, i.e., h₃*h₄s₂, tend to cancel each other due to their non-coherency, and the noise signal received in time slot #1, i.e., h₁*h₂s₂, and the noise signal received in time slot #5, i.e., h₃*h₂, tend to cancel each other due to their non-coherency. Therefore, the coherent combination of the desired signals |h₁|²s₁ and |h₃|²s₁ gives a 3 dB combining gain across two transmissions in slot #1 and slot #5.

Now, assuming that the channels for the two users do not change across repeated transmissions, that is h₁=h₃ and h₂=h₄ as shown in FIG. 11. In this case, the base station again performs equalization on the received signals and combines the two received signals (r₁ and r₂) to recover the signals for each of the UEs as below.

$$\begin{matrix}{\hat{s}}_{1} = {h}_{1}^{*} ( {h}_{1} {s}_{1} + {h}_{2} {s}_{2} + {n}_{1} ) + {h}_{1}^{*} ( {h}_{1} {s}_{1} + {h}_{2} {s}_{2} + {n}_{2} ) \\ = {\vert {h}_{1} \vert}^{2} {s}_{1} + {h}_{1}^{*} {h}_{2} {s}_{2} + {h}_{1}^{*} {n}_{1} + {\vert {h}_{1} \vert}^{2} {s}_{1} + {h}_{1}^{*} {h}_{2} {s}_{2} + {h}_{1}^{*} {n}_{2} \\ = 2 \cdot ( {\vert {h}_{1} \vert}^{2} {s}_{1} + {h}_{1}^{*} {h}_{2} {s}_{2} ) + {h}_{1}^{*} ( {n}_{1} + {n}_{2} )\end{matrix} \\ \begin{matrix}{\hat{s}}_{2} = {h}_{2}^{*} ( {h}_{1} {s}_{1} + {h}_{2} {s}_{2} + {n}_{1} ) + {h}_{2}^{*} ( {h}_{1} {s}_{1} + {h}_{2} {s}_{2} + {n}_{2} ) \\ = {\vert {h}_{2} \vert}^{2} {s}_{2} + {h}_{2}^{*} {h}_{1} {s}_{1} + {h}_{2}^{*} {n}_{1} + {\vert {h}_{2} \vert}^{2} {s}_{2} + {h}_{2}^{*} {h}_{1} {s}_{2} + {h}_{2}^{*} {n}_{2} \\ = 2 \cdot ( {\vert {h}_{2} \vert}^{2} {s}_{1} + {h}_{2}^{*} {h}_{1} {s}_{2} ) + {h}_{2}^{*} ( {n}_{1} + {n}_{2} )\end{matrix} \qquad ( 3 )$$

It can be seen that in this case, both the desired signals and interference signals transmitted in slot 1 combine coherently with the desired signals and interference signals transmitted in slot 5. The noise signal transmitted in slot 1, however, still combines non-coherently with the noise signal transmitted in slot 5. Therefore, if the interference from the other signal is dominant source of degradation, there may not be a 3 dB gain by combining two transmissions. In this case, the combined signal of slot 1 and slot 5 is almost a scaling of the transmitted signal in slot 1 only. It is probable that the transmitted signal can not be decoded at slot 5 when the transmitted signal can not be decoded at slot 1; consequently, close to a 100% error rate may occur for the transmissions in slot 5.

Hereinafter several embodiments of the present invention are disclosed, including an orthogonal repetition scheme. According to several embodiments of the present invention, a scheme is disclosed where repeated signals from multiple subscriber stations transmitting using the same time and frequency resources are spread using orthogonal functions, for example Fourier functions, Hadamard functions, or other orthogonal functions. It should be understood at the outset that although illustrative implementations of one or more embodiments are illustrated below, the disclosed systems and/or methods may be implemented using any number of techniques, whether currently known or in existence. The disclosure should in no way be limited to the illustrative implementations, drawings, and techniques illustrated below, but may be modified within the scope of the appended claims along with their full scope of equivalents.

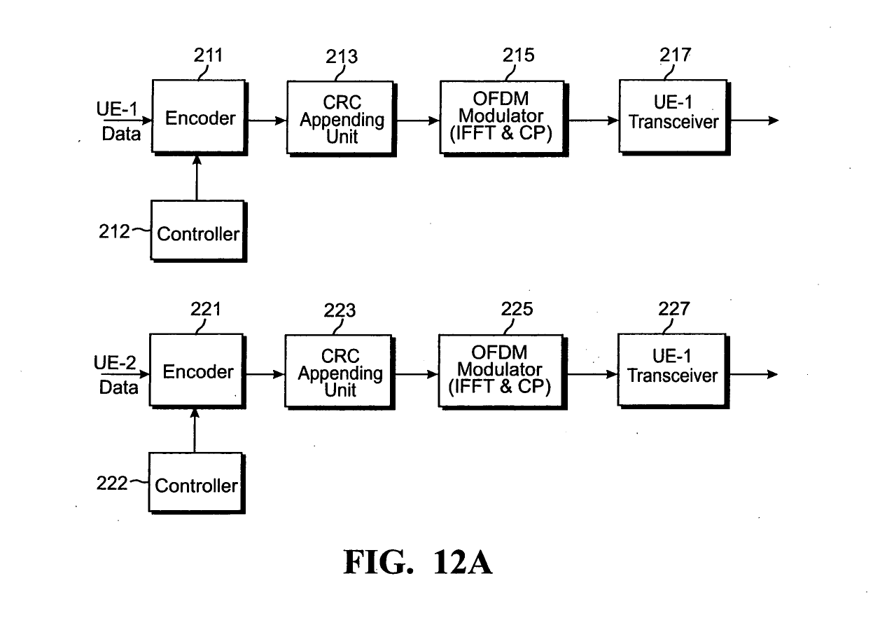

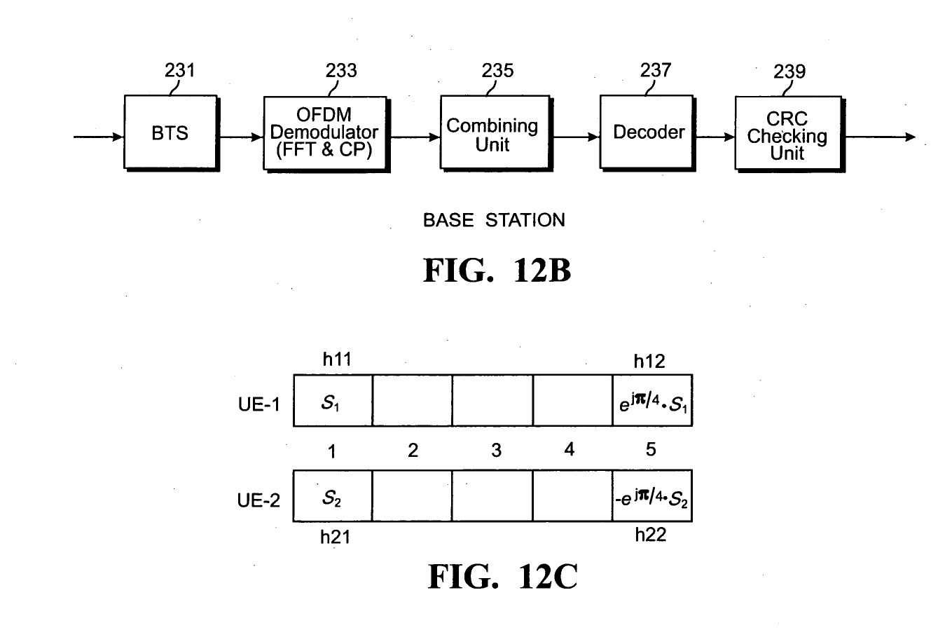

FIG. 12A is a block diagram of two units of user equipment (UEs) for uplink, i.e., for transmitting signals to a single base station of a wireless multi-user MIMO system. The user equipment employs the orthogonal repetition and Hybrid ARQ scheme according to the principles of the present invention. Each unit of user equipment, i.e., a transmitter, is constructed with a cyclic redundancy check (CRC) appending unit, a encoder, an OFDM modulator and a user equipment transmitter.

Referring to FIG. 12A, the controller controls the encoder to encode the input signal using a certain function such as either a Fourier function or a Hadamard function. The details of the encoding scheme will be explained in the following paragraphs. The coded signal is appended with CRC and is transmitted to the OFDM modulator. The OFDM modulator inverse-fast-Fourier-transform (IFFT) processes the coded signal, converts the signal to radio-frequency signal, and adds a cyclic prefix to the signal. The processed signal is transmitted through the user equipment transmitter.

Now the encoding function performed by the encoder will be explained. A Fourier matrix is a N×N square matrix with entries given by:

P_{N}=e^{j2πmn/N}m,n=0,1, . . . (N−1) (4)

For example, a 2×2 Fourier matrix can be expressed as:

$${P}_{2} = [ \begin{matrix}1 & 1 \\ 1 & {e}^{jπ}\end{matrix} ] = [ \begin{matrix}1 & 1 \\ 1 & - 1\end{matrix} ] \qquad ( 5 )$$

Similarly, a 4×4 Fourier matrix can be expressed as:

$${P}_{4} = [ \begin{matrix}1 & 1 & 1 & 1 \\ 1 & {e}^{jπ / 2} & {e}^{jπ} & {e}^{j3π / 2} \\ 1 & {e}^{jπ} & {e}^{j2π} & {e}^{j3π} \\ 1 & {e}^{j3π / 2} & {e}^{j3π} & {e}^{j9π / 2}\end{matrix} ] = [ \begin{matrix}1 & 1 & 1 & 1 \\ 1 & j & - 1 & - j \\ 1 & - 1 & 1 & - 1 \\ 1 & - j & - 1 & j\end{matrix} ] \qquad ( 6 )$$

Multiple Fourier matrices can be defined by introducing a shift parameter (g/G) in the Fourier matrix. The entry of the multiple Fourier matrices is given by:

$${P}_{mn} = {e}^{j2π \frac{m}{N} ( n + \frac{g}{G} )} \\ m , n = 0 , 1 , … ( N - 1 ) \qquad ( 7 )$$

A set of four 2×2 Fourier matrices can be defined by taking G=4, and g=0, 1, 2 and 3 are written as:

$$\begin{matrix}{P}_{2}^{0} = [ \begin{matrix}1 & 1 \\ 1 & - 1\end{matrix} ] & ( 8 ) \\ {P}_{2}^{1} = [ \begin{matrix}1 & 1 \\ {e}^{jπ / 4} & - {e}^{jπ / 4}\end{matrix} ] & ( 9 ) \\ {P}_{2}^{2} = [ \begin{matrix}1 & 1 \\ {e}^{jπ / 2} & - {e}^{jπ / 2}\end{matrix} ] & ( 10 ) \\ {P}_{2}^{3} = [ \begin{matrix}1 & 1 \\ {e}^{j3π / 4} & - {e}^{j3π / 4}\end{matrix} ] & ( 11 )\end{matrix}$$

Assume that Fourier matrix P₂¹ in equation 9 is used for encoding the signals S₁ and S₂ to be transmitted from the equipment of two users (UEs) for the uplink in the multi-user MIMO wireless system. Assume that user equipment 1 (UE-1) uses first column of P₂¹ to pre-code its first transmission in slot 1 and successive retransmittion in slot 2, while UE-2 uses second column of P₂¹. Let T₁₁ and T₁₂ denote first and second transmitted symbols from UE-1 in slot 1 and slot 5 respectively, while T₂₁ and T₂₂ denote first and second transmitted symbols from UE-2 in slot 1 and slot 5 respectively, as shown in FIG. 12C. The transmitted symbols T₁₁, T₁₂, T₂₁ and T₂₂ are then given as:

$$\begin{matrix}[ \begin{matrix}{T}_{11} \\ {T}_{12}\end{matrix} ] = {S}_{1} \cdot [ \begin{matrix}1 \\ {e}^{jπ / 4}\end{matrix} ] = [ \begin{matrix}{S}_{1} \\ {e}^{jπ / 4} \cdot {S}_{1}\end{matrix} ] & ( 12 ) \\ [ \begin{matrix}{T}_{21} \\ {T}_{22}\end{matrix} ] = {S}_{2} \cdot [ \begin{matrix}1 \\ - {e}^{jπ / 4}\end{matrix} ] = [ \begin{matrix}{S}_{2} \\ - {e}^{jπ / 4} \cdot {S}_{2}\end{matrix} ] & ( 13 )\end{matrix}$$

### Therefore, the signals transmitted from UE-1 in slot 1 and slot 5 are S₁ and e^{jπ/4}·S₁, respectively, while signals transmitted from UE-2 in slot 1 and slot 5 are S₂ and −e^{jπ/4}·S₂, respectively.

FIG. 12B is a block diagram of a base station in the uplink receiving signals transmitted from a plurality of user equipments. The base station, i.e., a receiver, is constructed with a base transceiver station (BTS) 231, an OFDM demodulator 233, a combining unit 235, a decoder 237 and a CRC checking unit 239.

Referring to FIG. 12B, BTS 231 receives the signals transmitted from a plurality of units of user equipment. OFDM demodulator 223 demodulates the received signals. Combining unit 235 combines the signals from different equipments. Decoder 237 decodes the signals according to the encoding information in the transmitter side. CRC checking unit 239 determines whether the data received by the BTS is correct. If the received data is not correct, CRC checking unit sends a negative acknowledgment (NACK) signal to the controller of the user equipment and the user equipment will send another frame of data.

The decoding scheme will now be explained. Let h₁ and h₁₂ denote channel gains between UE-1 and the base station in slot 1 and slot 5, respectively, while h₂₁ and h₂₂ denote channel gains between UE-2 and the base station in slot 1 and slot 5, respectively. The received symbols r₁ and r₂ in slot 1 and slot 5 can be written as:

r₁=h₁₁S₁+h₂₁S₂+n₁ (14)

r₂=h₁₂·e^{jπ/4}S₁+h₁₂·(−e^{jπ/4}S₂)+n₂ (15)

Equations 14 and 15 can be combined into a matrix format.

$$[ \begin{matrix}{r}_{1} \\ {r}_{2}\end{matrix} ] = [ \begin{matrix}{h}_{11} \\ {h}_{12}\end{matrix} ] \cdot [ \begin{matrix}{S}_{1} \\ {e}^{jπ / 4} \cdot {S}_{1}\end{matrix} ] + [ \begin{matrix}{h}_{21} \\ {h}_{22}\end{matrix} ] \cdot [ \begin{matrix}{S}_{2} \\ - {e}^{jπ / 4} \cdot {S}_{2}\end{matrix} ] + [ \begin{matrix}{n}_{1} \\ {n}_{2}\end{matrix} ] \\ [ \begin{matrix}{r}_{1} \\ {r}_{2}\end{matrix} ] = [ \begin{matrix}{h}_{11} {S}_{1} + {h}_{21} \cdot {S}_{2} + {n}_{1} \\ {h}_{12} \cdot {e}^{jπ / 4} \cdot {S}_{1} - {h}_{22} \cdot {e}^{jπ / 4} \cdot {S}_{2} + {n}_{2}\end{matrix} ] \qquad ( 16 )$$

Therefore, the effective channel between the two UEs and the base station including the effect of Fourier spreading and the channel gain can be written as:

$$H = [ \begin{matrix}{h}_{11} & {h}_{21} \\ {h}_{12} & {h}_{22}\end{matrix} ] \cdot [ \begin{matrix}1 & 1 \\ {e}^{jπ / 4} & - {e}^{jπ / 4}\end{matrix} ] = [ \begin{matrix}{h}_{11} & {h}_{21} \\ {h}_{12} \cdot {e}^{jπ / 4} & - {h}_{22} \cdot {e}^{jπ / 4}\end{matrix} ] \qquad ( 17 )$$

The received signals are decoded to recover the signals Ŝ₁₁ and Ŝ₂ for UE-1 and UE-2:

$$[ \begin{matrix}{\hat{S}}_{1} \\ {\hat{S}}_{2}\end{matrix} ] = {H}^{H} \times [ \begin{matrix}{r}_{1} \\ {r}_{2}\end{matrix} ] \qquad ( 18 )$$

where H^{H} denote the Hermitian transpose of H, i.e, H^{H}=(H*)^{T}. Therefore,

$$[ \begin{matrix}{\hat{S}}_{1} \\ {\hat{S}}_{2}\end{matrix} ] = [ \begin{matrix}{h}_{11}^{*} & {h}_{12}^{*} \cdot {e}^{- jπ / 4} \\ {h}_{21}^{*} & - {h}_{22}^{*} \cdot {e}^{- jπ / 4}\end{matrix} ] \times [ \begin{matrix}{h}_{11} {S}_{1} + {h}_{21} \cdot {S}_{2} + {n}_{1} \\ {h}_{12} \cdot {e}^{jπ / 4} \cdot {S}_{1} - {h}_{22} \cdot {e}^{jπ / 4} \cdot {S}_{2} + {n}_{2}\end{matrix} ] \\ [ \begin{matrix}{\hat{S}}_{1} \\ {\hat{S}}_{2}\end{matrix} ] = \\ [ \begin{matrix}{h}_{11}^{2} {S}_{1} + {h}_{11}^{*} \cdot {h}_{21} \cdot {S}_{2} + {h}_{11}^{*} \cdot {n}_{1} + {h}_{12}^{2} \cdot {S}_{1} - {h}_{12}^{*} \cdot {h}_{22} \cdot {S}_{2} + {h}_{12}^{*} \cdot {e}^{- jπ / 4} \cdot {n}_{2} \\ {h}_{21}^{*} \cdot {h}_{11} {S}_{1} + {h}_{21}^{2} \cdot {S}_{2} + {h}_{21}^{*} \cdot {n}_{1} - {h}_{22}^{*} \cdot {h}_{12} \cdot {S}_{1} + {h}_{22}^{2} {S}_{2} - {h}_{22}^{*} \cdot {e}^{- jπ / 4} \cdot {n}_{2}\end{matrix} ] \qquad ( 19 )$$

We assume that the channels for the two users do not change across repeated transmissions, that is h₁₁=h₁₂=h₁ and h₂₁=h₂₂=h₂. Therefore, the above expression can be simplified as:

$$\begin{matrix}[ \begin{matrix}{\hat{S}}_{1} \\ {\hat{S}}_{2}\end{matrix} ] = [ \begin{matrix}{h}_{1}^{2} {S}_{1} + {h}_{1}^{*} \cdot {h}_{2} \cdot {S}_{2} + {h}_{1}^{*} \cdot {n}_{1} + {h}_{1}^{2} \cdot {S}_{1} - {h}_{1}^{*} \cdot {h}_{2} \cdot {S}_{2} + {h}_{1}^{*} \cdot {e}^{- jπ / 4} \cdot {n}_{2} \\ {h}_{2}^{*} \cdot {h}_{1} {S}_{1} + {h}_{2}^{2} \cdot {S}_{2} + {h}_{2}^{*} \cdot {n}_{1} - {h}_{2}^{*} \cdot {h}_{1} \cdot {S}_{1} + {h}_{2}^{2} {S}_{2} - {h}_{2}^{*} \cdot {e}^{- jπ / 4} \cdot {n}_{2}\end{matrix} ] \\ = [ \begin{matrix}2 {h}_{1}^{2} \cdot {S}_{1} + {h}_{1}^{*} \cdot {n}_{1} + {h}_{1}^{*} \cdot {e}^{- jπ / 4} \cdot {n}_{2} \\ 2 {h}_{2}^{2} \cdot {S}_{2} + {h}_{2}^{*} \cdot {n}_{1} - {h}_{2}^{*} \cdot {e}^{- jπ / 4} \cdot {n}_{2}\end{matrix} ]\end{matrix} \qquad ( 20 )$$

### It can be seen that the transmission by each user completely removes interference from the other user.

In fact, the order of transmission of symbols S₁ and e^{jπ/4}. S₁ by UE-1 is not limited to that in the first embodiment; similarly, the order of transmission of symbols S₂ and −e^{jπ/4}. S₂ by UE-2 is not limited to that in the first embodiment. For example, in slot #1, UE-1 may transmit S₁ and UE-2 may transmit −e^{jπ/4}·S₂; and in slot #5, UE-1 may transmit e^{jπ/4}·S₁ and UE-2 may transmit S₂. In this case, let T₁₁ and T₁₂ denote first and second transmitted symbols from UE-1 in slot 1 and slot 5 respectively, while T₂₁ and T₂₂ denote first and second transmitted symbols from UE-2 in slot 1 and slot 5 respectively. Therefore, the transmitted symbols T₁₁, T₁₂, T₂₁ and T₂₂ are given as:

$$\begin{matrix}[ \begin{matrix}{T}_{11} \\ {T}_{12}\end{matrix} ] = [ \begin{matrix}{S}_{1} \\ {e}^{jπ / 4} \cdot {S}_{1}\end{matrix} ] & ( 21 ) \\ [ \begin{matrix}{T}_{21} \\ {T}_{22}\end{matrix} ] = [ \begin{matrix}- {e}^{jπ / 4} \cdot {S}_{2} \\ {S}_{2}\end{matrix} ] & ( 22 )\end{matrix}$$

Let h₁₁ and h₁₂ denote channel gains between UE-1 and the base station in slot 1 and slot 5, respectively, while h₂₁ and h₂₂ denote channel gains between UE-2 and the base station in slot 1 and slot 5, respectively. The received symbols r₁ and r₂ in slot 1 and slot 5 can be written as:

$$[ \begin{matrix}{r}_{1} \\ {r}_{2}\end{matrix} ] = [ \begin{matrix}{h}_{1} \cdot {S}_{1} + {h}_{2} \cdot ( - {e}^{jπ / 4} \cdot {S}_{2} ) + {n}_{1} \\ {h}_{1} \cdot {e}^{jπ / 4} \cdot {S}_{1} + {h}_{2} \cdot {S}_{2} + {n}_{2}\end{matrix} ] \qquad ( 23 )$$

When the transmission order is changed, the detection also needs to be changed accordingly. Therefore, the estimated symbols at UE-1 and UE-2 are:

$$[ \begin{matrix}{\hat{S}}_{1} \\ {\hat{S}}_{2}\end{matrix} ] = [ \begin{matrix}{h}_{11}^{*} & {h}_{12}^{*} \cdot {e}^{- jπ / 4} \\ - {h}_{21}^{*} \cdot {e}^{- jπ / 4} & {h}_{22}^{*}\end{matrix} ] \times [ \begin{matrix}{h}_{11} {S}_{1} - {h}_{21} \cdot {e}^{- jπ / 4} \cdot {S}_{2} + {n}_{1} \\ {h}_{12} \cdot {e}^{- jπ / 4} \cdot {S}_{1} + {h}_{22} \cdot {S}_{2} + {n}_{2}\end{matrix} ] \\ [ \begin{matrix}{\hat{S}}_{1} \\ {\hat{S}}_{2}\end{matrix} ] = [ \begin{matrix}{h}_{11}^{2} {S}_{1} - {h}_{11}^{*} \cdot {h}_{21} \cdot {e}^{- jπ / 4} {S}_{2} + {h}_{11}^{*} \cdot {n}_{1} + {h}_{12}^{2} \cdot {S}_{1} + {h}_{12}^{*} \cdot {h}_{22} \cdot {e}^{- jπ / 4} {S}_{2} + {h}_{12}^{*} \cdot {e}^{- jπ / 4} \cdot {n}_{1} \\ - {h}_{21}^{*} \cdot {h}_{11} \cdot {e}^{- jπ / 4} {S}_{1} + {h}_{21}^{2} \cdot {S}_{2} - {h}_{21}^{*} \cdot {e}^{- jπ / 4} \cdot {n}_{1} + {h}_{22}^{*} \cdot {h}_{12} \cdot {e}^{- jπ / 4} \cdot {S}_{1} + {h}_{22}^{2} {S}_{2} + {h}_{22}^{*} \cdot {n}_{1}\end{matrix} ] \qquad ( 24 )$$

If we assume that the channels for the two users do not change across repeated transmissions, that is h₁₁=h₁₂=h₁ and h₂₁=h₂₂=h₂, then the above expression can be simplified as:

$$[ \begin{matrix}{\hat{S}}_{1} \\ {\hat{S}}_{2}\end{matrix} ] = [ \begin{matrix}2 {h}_{1}^{2 } \cdot {S}_{1} + {h}_{1}^{*} \cdot {n}_{1} + {h}_{1}^{*} \cdot {e}^{- jπ / 4} \cdot {n}_{1} \\ 2 {h}_{2}^{2} \cdot {S}_{2} - {h}_{2}^{*} \cdot {e}^{- jπ / 4} \cdot {n}_{1} + {h}_{2}^{*} \cdot {n}_{1}\end{matrix} ] \qquad ( 25 )$$

### It can be seen that each user completely removes interference from the other user.

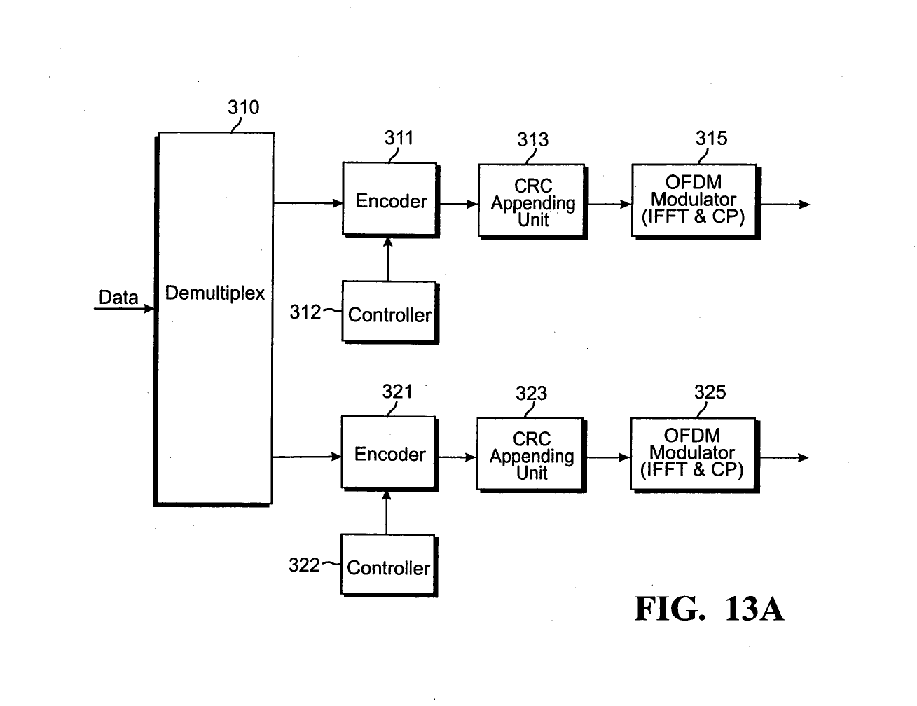

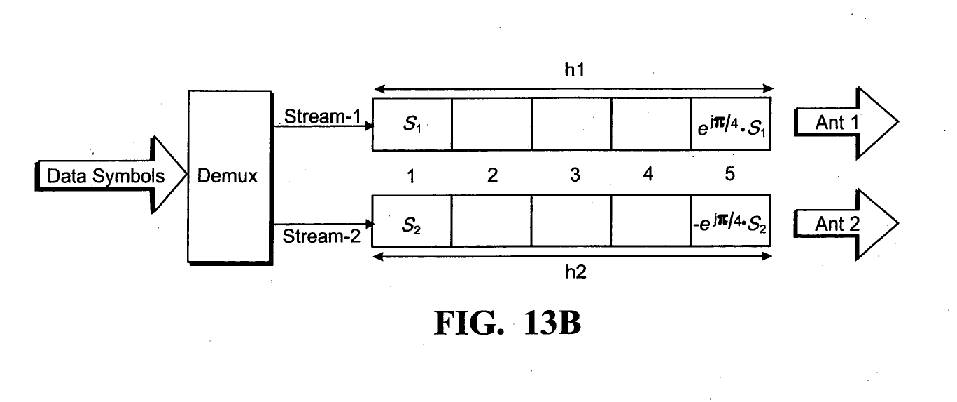

In a second embodiment of the present invention, the interference cancellation principle of the current invention is applied to cancel interference for multiple data streams transmitted from the same user as shown in FIG. 13A. The data symbols to be transmitted are first demultiplexed by demultiplex unit 310 into multiple data streams. Each data stream is coded and spread using either a Fourier function or a Hadamard function, by encoder 311. Since the encoding and decoding schemes are similar to that of the first embodiment when multiple data streams are transmitted by multiple users, the explanation regarding the encoding and decoding schemes thereof need not be expanded beyond that provided here.

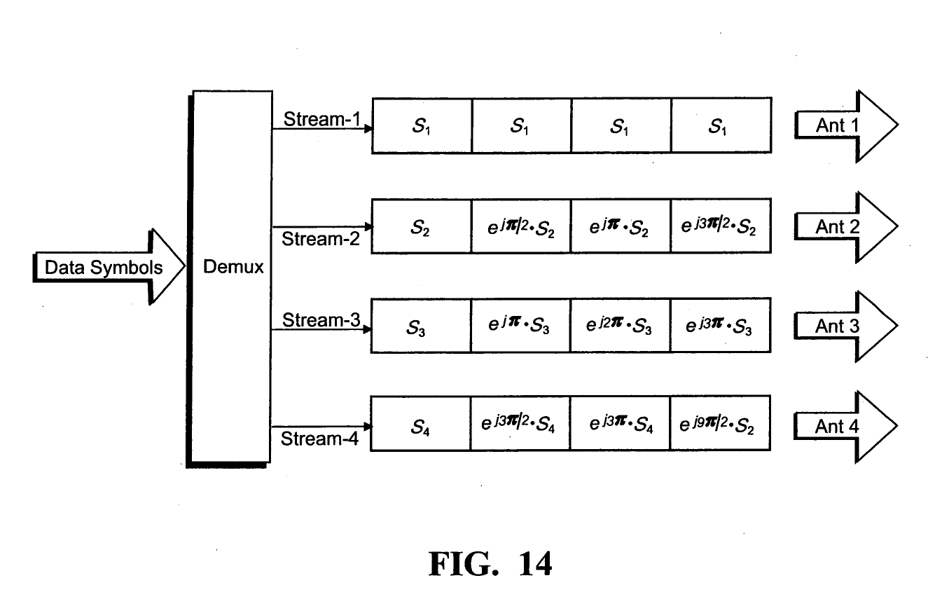

In the third embodiment of the present invention shown in FIG. 14, a P₄ Fourier matrix given in equation 6 is used to spread repeated symbols in a four-stream single user MIMO system. It should be noted that symbols can be repeated either in response to a Hybrid ARQ NACK or without receiving any hybrid ARQ feedback. Also, the P₄ Fourier matrix can be applied to repeated symbols transmitted from four UEs in an uplink multi-user MIMO.

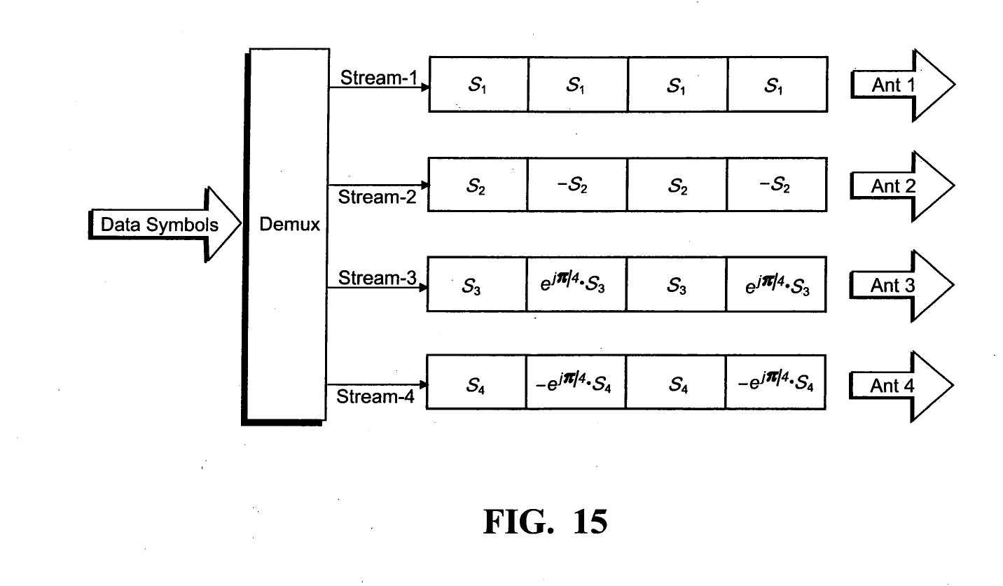

In the fourth embodiment of the current invention shown in FIG. 15, two 2×2 Fourier matrices P₂⁰ and P₂¹ given in equations 8 and 9 are used to spread repeated symbols in a four-stream single user MIMO system. In this example, stream-1 and stream-2 are spread using P₂⁰ while stream-3 and stream-4 are spread using P₂¹. Note that the same principle can be applied when stream-1 and stream-2 are transmitted to UE-1 while stream-3 and stream-4 are transmitted to another UE-2.

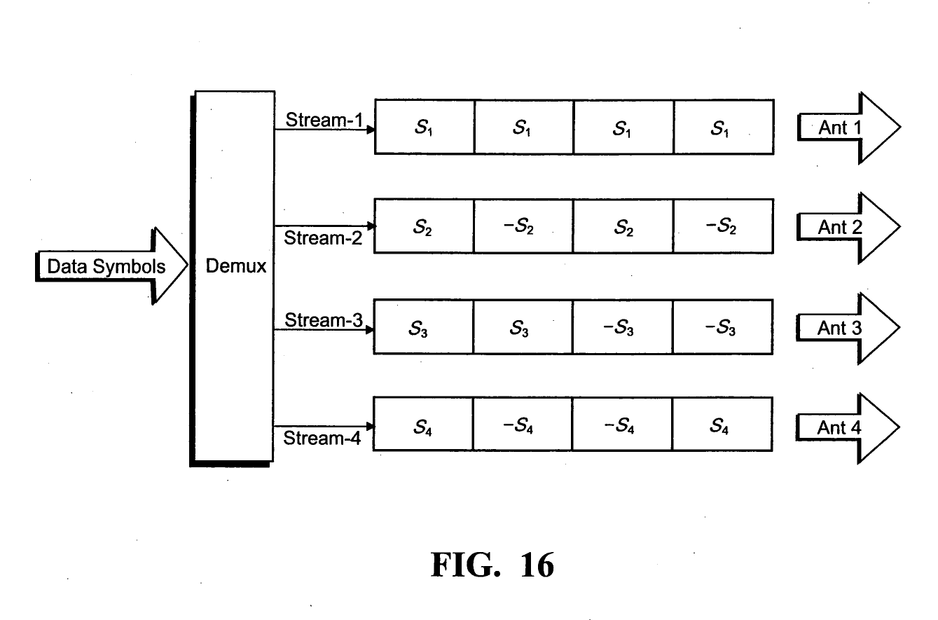

In the fifth embodiment of the present invention shown in FIG. 16, a 4×4 Hadamnard matrix given below is used to spread repeated symbols in a four-stream single-user MIMO system.

$${H}_{4} = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] \qquad ( 26 )$$

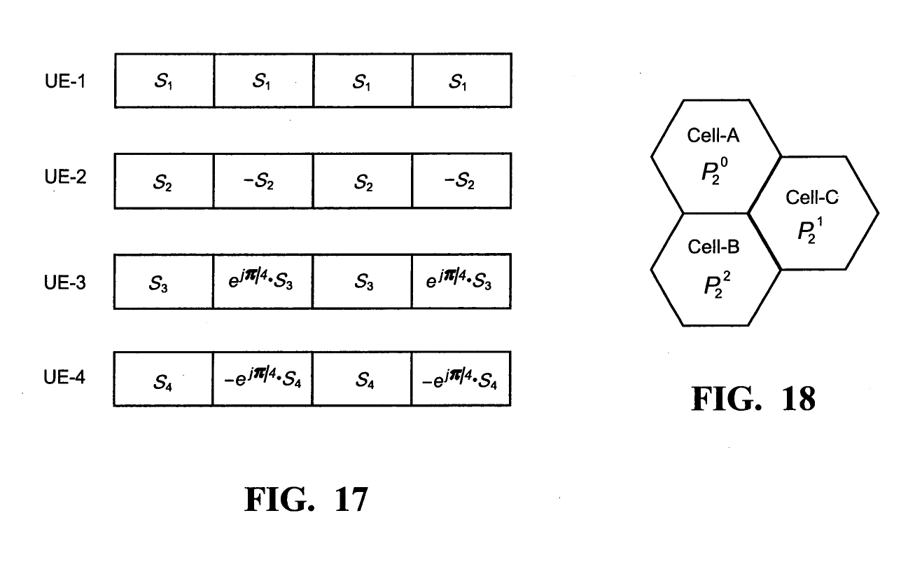

FIGS. 17-19 will be discussed below with respect to the following matrices:

$$\begin{matrix}{P}_{2}^{0} = [ \begin{matrix}1 & 1 \\ 1 & - 1\end{matrix} ] & ( 8 ) \\ {P}_{2}^{1} = [ \begin{matrix}1 & 1 \\ {e}^{jπ / 4} & - {e}^{jπ / 4}\end{matrix} ] & ( 9 ) \\ {P}_{2}^{2} = [ \begin{matrix}1 & 1 \\ {e}^{jπ / 2} & - {e}^{jπ / 2}\end{matrix} ] & ( 10 )\end{matrix}$$

In the sixth embodiment of the present invention shown in FIG. 17, two 2×2 Fourier matrices P₂⁰ and P₂¹ are used to spread repeated symbols from four UEs. In this example, UE-1 and UE-2 use P₂⁰ while UE-3 and UE-4 use P₂¹.

In the seventh embodiment of the present invention shown in FIG. 18, different Fourier matrices P₂⁰, P₂¹ and P₂² are respectively used in the neighboring cells Cell-A, Cell-B and Cell-C. This enables de-correlating of interference that occurs between the neighboring cells when transmissions from one cell are repeated in the neighboring cells as well.

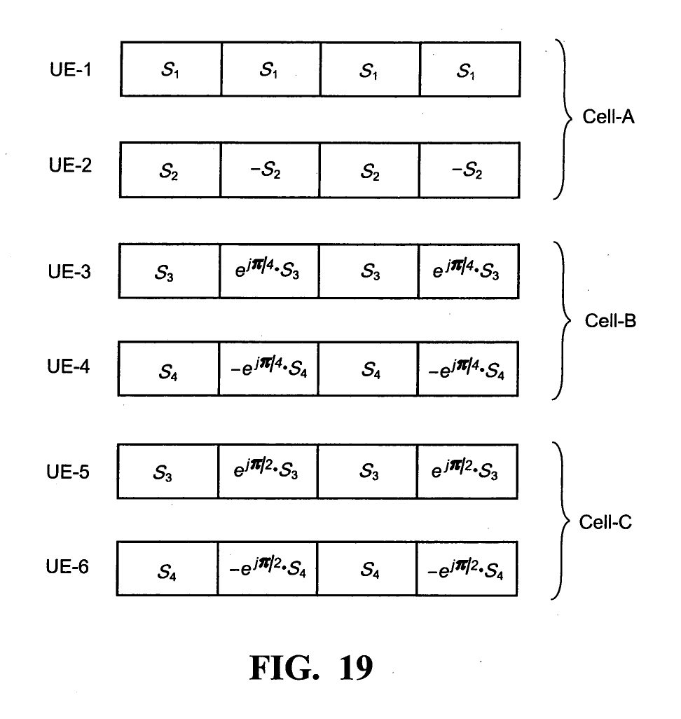

In FIG. 19, six UEs with two UEs in each of the three cells Cell-A, Cell-B and Cell-C represented in FIG. 18 use three different 2×2 Fourier Matrices P₂¹ P₂¹ and P₂² according to the seventh embodiment of the present invention. In this example, UE-1 and UE-2 share P₂⁰, UE-3 and UE-4 share P₂¹ and UE-5 and UE-6 share P₂².

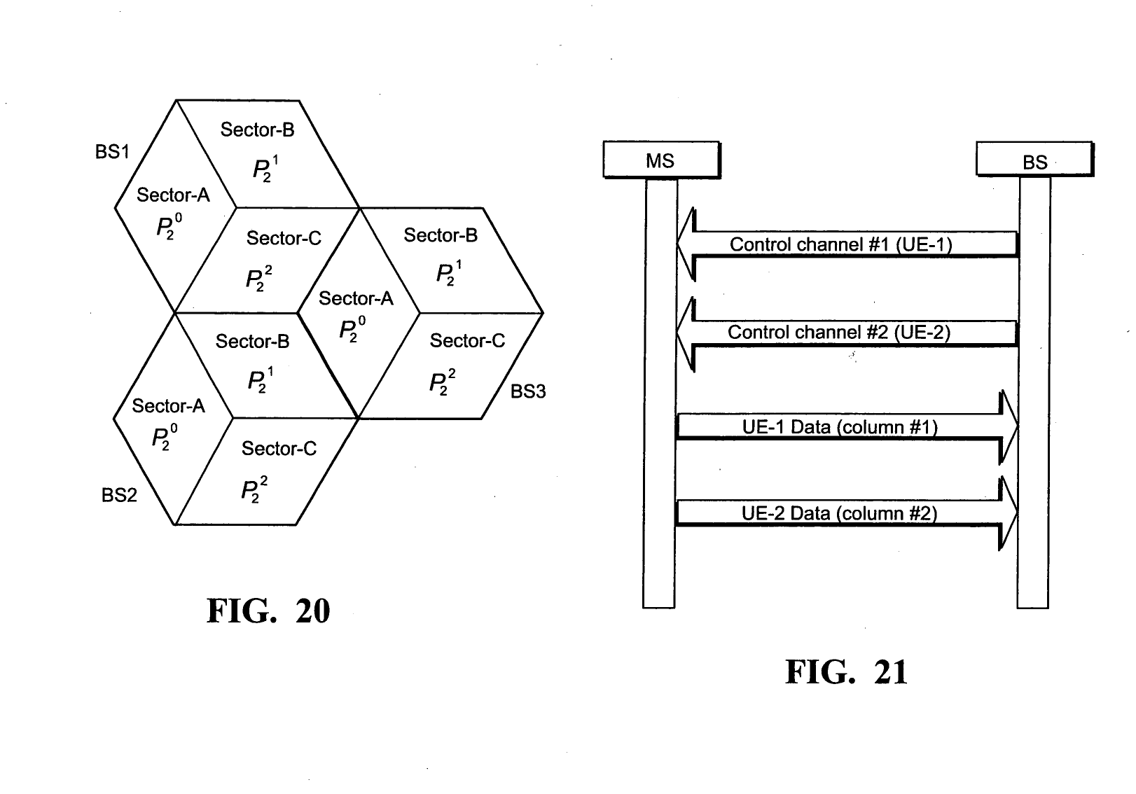

In the eighth embodiment of the current invention shown in FIG. 20, different Fourier matrices are used in different sectors of a base station. Different data streams transmitted from the same user or from multiple users use different columns of the matrix for transmission.

In the ninth embodiment of the current invention shown in FIG. 21, the signaling of which column of the matrix to use for transmission is coupled to control channel ID. In the example of FIG. 21, scheduling grant for user-A is transmitted on control channel #1 and hence it uses the first column of the matrix for its transmission. The scheduling grant for user-B is transmitted on control channel #2 and hence it uses the second column of the matrix for its transmission. It is also possible to explicitly indicate the column of the matrix in the control message. In case of MIMO, when all the streams are transmitted to/from a single user, the use of the matrix can be predetermined or signaled by the base station. Alternatively, in the nineth embodiment, as well as in the other embodiments, it is possible to indicate both matrix and column dynamically and explicitly with the scheduling grant.

What is claimed is:

1. A communication network, comprising:
a base transceiver station disposed to communicate with a plurality of subscriber stations by scheduling the transmission of a first symbol representing a first packet of user data by a first subscriber station and the transmission of a second symbol representing a second packet of user data by a second subscriber station in an uplink to the base transceiver station in common time and frequency slots, with:
the base transceiver station instructing the first and second subscriber stations to generate a first orthogonal spread symbol and a second orthogonal spread symbol by respectively orthogonally spreading the first and second symbols based on an orthogonal spread matrix, with the first orthogonal spread symbol corresponding to the first symbol, and the second orthogonal spread symbol corresponding to the second symbol;
the base transceiver station scheduling the first subscriber station to transmit either one of the first symbol and the first orthogonal spread symbol in a first time and frequency slot, and scheduling the first subscriber station to transmit the other one of the first symbol and the first orthogonal spread symbol in a second time and frequency slot;
the base transceiver station scheduling the second subscriber station to transmit either one of the second symbol and the second orthogonal spread symbol in the first time and frequency slot, and scheduling the second subscriber station to transmit the other one of the second symbol and the second orthogonal spread symbol in a second time and frequency slot.

2. The communication network of claim 1, with the orthogonal spread matrix being either one of a Fourier matrix and a Hadamard matrix.

3. The communication network of claim 2, with each element of the Fourier matrix being established by:
$${P}_{mn} = {e}^{j2π \frac{m}{N} ( n + \frac{g}{G} )} , where m , n = 0 , 1 , ⋯ ( N - 1 ) and$$
where N is the dimension of the Fourier matrix, G is the total number of matrices generated, m is the row number of the element, n is the column number of the element, and g is selected to be any number between 0 and G−1.

4. The communication network of claim 3, with N being selected to equal the number of the subscriber stations simultaneously instructed by the base transceiver station to make transmissions within the same time and frequency slot.

5. The communication network of claim 1, with the base transceiver station transmitting control messages to the first and second subscriber stations, the control message including which orthogonal spread matrix to use and which column of the orthogonal spread matrix to use for respectively generating the first and second orthogonal spread symbols.

6. The communication network of claim 1, with:
an identification number for a first channel through which the base transceiver station sends scheduling instructions to the first subscriber station determines which column of the orthogonal spread matrix to use for generating the first orthogonal spread symbol; and
an identification number for a second channel through which the base transceiver station sends the scheduling instructions to the second subscriber station that determines which column of the orthogonal spread matrix to use for generating the second orthogonal spread symbol.

7. The communication network of claim 1, when the base transceiver station receives the symbols transmitted by the subscriber stations, with the base transceiver station demodulating the received symbols by using the orthogonal spread matrix.

8. A method for a base transceiver station communicating with a plurality of subscriber stations in common time and frequency slots, to instruct data transmission by the subscriber stations, the method comprising the steps of:
transmitting control messages to a first subscriber station and a second subscriber station, the control message including information of an orthogonal spread matrix;
instructing the first and second subscriber station to respectively orthogonally spread a first symbol generated by the first subscriber station and a second symbol generated by the second subscriber station based on the orthogonal spread matrix, the resulting symbols being a first orthogonal spread symbol corresponding to the first symbol and a second orthogonal spread symbol corresponding to the second symbol;
scheduling the first subscriber station to transmit either one of the first symbol and the first orthogonal spread symbol in a first time and frequency slot, and scheduling the first subscriber station to transmit the other one of the first symbol and the first orthogonal spread symbol in a second time and frequency slot; and
scheduling the second subscriber station to transmit either one of the second symbol and the second orthogonal spread symbol in the first time and frequency slot, and scheduling the second subscriber station to transmit the other one of the second symbol and the second orthogonal spread symbol in a second time and frequency slot.

9. The method of claim 8, with to the orthogonal spread matrix being either one of a Fourier matrix and a Hadamard matrix.

10. The method of claim 9, with the each element of the Fourier matrix being established by:
$${P}_{mn} = {e}^{j2π \frac{m}{N} ( n + \frac{g}{G} )} , where m , n = 0 , 1 , ⋯ ( N - 1 ) and$$
where N is the dimension of the Fourier matrix, G is the total number of matrices generated, m is the row number of the element, n is the column number of the element, and g is selected to be any number between 0 and G−1.

11. The method of claim 10, with N being selected to equal the number of the subscriber stations simultaneously instructed by the base transceiver station to make transmissions within the same time and frequency slot.

12. The method of claim 8, with the control message further including which orthogonal spread matrix to use and which column of the orthogonal spread matrix to use for respectively generating the first and second orthogonal spread symbols.

13. The method of claim 8, with:
an identification number for a first channel through which the base transceiver station sends scheduling instructions to the first subscriber station determines which column of the orthogonal spread matrix to use for generating the first orthogonal spread symbol; and
an identification number for a second channel through which the base transceiver station sends the scheduling instructions to the second subscriber station that determines which column of the orthogonal spread matrix to use for generating the second orthogonal spread symbol.

14. The wireless network of claim 8, when the base transceiver station receives the symbols transmitted by the subscriber stations, with the base transceiver station demodulating the received symbols by using the orthogonal spread matrix.

15. A communication network, comprising:
a plurality of base transceiver stations, each covering a corresponding cell and communicating with a plurality of subscriber stations situated within the cell, by scheduling the subscriber stations to transmit symbols in an uplink to the base transceiver station in common time and frequency slots, with:
each of the base transceiver stations instructing the subscriber stations within the corresponding cell to orthogonally spread corresponding original symbols for generating orthogonal spread symbols based on an orthogonal spread matrix, with different orthogonal spread matrices being used for different cells; and
each of the base transceiver stations scheduling the subscriber stations within the corresponding cell to sequentially transmit one of the original symbol and the orthogonally spread symbols in different time and frequency slots.

16. The communication network of claim 15, with the orthogonal spread matrix being a Fourier matrix, and each element of the Fourier matrix being established by:
$${P}_{mn} = {e}^{j2π \frac{m}{N} ( n + \frac{g}{G} )} , where m , n = 0 , 1 , ⋯ ( N - 1 ) and$$
where N is the dimension of the Fourier matrix, G is the total number of matrices generated, m is the row number of the element, n is the column number of the element, and g is selected to be any number between 0 and G−1.

17. The communication network of claim 15, with each cell comprising a plurality of sectors, and each of the base transceiver stations instructing the subscriber stations within the corresponding sectors to orthogonally spread corresponding original symbols for generating orthogonal spread symbols based on an orthogonal spread matrix, with different orthogonal spread matrices being used for different sectors.

18. A subscriber station adapted to communicate with a base transceiver station in response to being scheduled by the base transceiver station of the transmission of a first symbol in an uplink to the base transceiver station simultaneously with another subscriber station in common time and frequency slots, with:
the subscriber station receiving an orthogonal spread matrix from the base transceiver station, and orthogonally spreading the first symbol based on the orthogonal spread matrix to generate a first orthogonal spread symbol corresponding to the first symbol, while a second symbol from a second subscriber station based on the orthogonal spread matrix to generate a second orthogonal spread symbol corresponding to the second symbol; and
the subscriber station transmitting either one of the first symbol and the first orthogonal spread symbol in a first time and frequency slot, and transmitting the other one of the first symbol and the first orthogonal spread symbol in a second time and frequency slot, while the second subscriber station transmitting either one of the second symbol and the second orthogonal spread symbol in the first time and frequency slot, and transmitting the other one of the second symbol and the second orthogonal spread symbol in the second time and frequency slot.

19. The subscriber station of claim 18, with the orthogonal spread matrix being either one of a Fourier matrix and a Hadamard matrix.

20. The subscriber station of claim 18, with each element of the Fourier matrix being established by:
$${P}_{mn} = {e}^{j2π \frac{m}{N} ( n + \frac{g}{G} )} , where m , n = 0 , 1 , ⋯ ( N - 1 ) and$$
where N is the dimension of the Fourier matrix, G is the total number of matrices generated, m is the row number of the element, n is the column number of the element, and g is selected to be any number between 0 and G−1.

21. A communication network, comprising:
a base transceiver station disposed to communicate with N subscriber stations by scheduling transmission in an uplink to the base transceiver station in common time and frequency slots, with:
the base transceiver station transmitting an orthogonal spread matrix to the plurality of subscriber stations, with N corresponding to the number of the subscriber stations simultaneously scheduled by the base transceiver station;
the base transceiver station instructing each subscriber station to orthogonally spread corresponding original symbols that the subscriber station intends to transmit for generating N−1 orthogonal spread symbols based on the orthogonal spread matrix; and
the base transceiver station scheduling each subscriber station to sequentially transmit the original symbol or either one of the N−1 orthogonal spread symbols in N time and frequency slot.

22. The communication network of claim 21, with the orthogonal spread matrix being either one of a Fourier matrix and a Hadamard matrix.

23. The communication network of claim 22, with each element of the Fourier matrix being established by:
$${P}_{mn} = {e}^{j2π \frac{m}{N} ( n + \frac{g}{G} )} , where m , n = 0 , 1 , ⋯ ( N - 1 ) and$$
where N is the dimension of the Fourier matrix, G is the total number of matrices generated, m is the row number of the element, n is the column number of the element, and g is selected to be any number between 0 and G−1.

24. A communication network, comprising:
a receiver disposed to communicate with a transmitter by scheduling transmissions of a first symbol and a second symbol in common time and frequency slots, with:
the receiver instructing the transmitter to orthogonally spread the first and second symbols based on an orthogonal spread matrix for generating a first orthogonal spread symbol corresponding to the first symbol and a second orthogonal spread symbol corresponding to the second symbol;
the receiver scheduling the transmitter to transmit, via a first transmission channel, either one of the first symbol and the first orthogonal spread symbol in a first time and frequency slot, and scheduling the transmitter to transmit, via the first transmission channel, the other one of the first symbol and the first orthogonal spread symbol in a second time and frequency slot; and
the receiver scheduling the transmitter to transmit, via a second transmission channel, either one of the second symbol and the second orthogonal spread symbol in the first time and frequency slot, and scheduling the transmitter to transmit, via the second transmission channel, the other one of the second symbol and the second orthogonal spread symbol in the second time and frequency slot.

25. The communication network of claim 24, with the orthogonal spread matrix being either one of a Fourier matrix and a Hadamard matrix.

26. The communication network of claim 25, with each element of the Fourier matrix being established by:
$${P}_{mn} = {e}^{j2π \frac{m}{N} ( n + \frac{g}{G} )} , where m , n = 0 , 1 , ⋯ ( N - 1 ) and$$
where N is the dimension of the Fourier matrix, G is the total number of matrices generated, m is the row number of the element, n is the column number of the element, and g is selected to be any number between 0 and G−1.

27. The communication network of claim 24, with the receiver transmitting control messages to the transmitter, the control message including which orthogonal spread matrix to use and which column of the orthogonal spread matrix to use for respectively generating the first and second orthogonal spread symbols.

28. The communication network of claim 24, with:
an identification number for the first transmission channel determines which column of the orthogonal spread matrix to use for generating the first orthogonal spread symbol; and
an identification number for the second transmission channel determines which column of the orthogonal spread matrix to use for generating the second orthogonal spread symbol.

29. The communication network of claim 24, when the receiver receives the symbols transmitted by the transmitter, with the receiver demodulating the received symbols by using the orthogonal spread matrix.

30. A method for a receiver to instruct a transmitter to transmit a first symbol and a second symbol in common time and frequency slots, the method comprising the steps of:
instructing the transmitter to orthogonally spread the first and second symbols based on an orthogonal spread matrix for generating a first orthogonal spread symbol corresponding to the first symbol and a second orthogonal spread symbol corresponding to the second symbol;
scheduling the transmitter to transmit, via a first transmission channel, either one of the first symbol and the first orthogonal spread symbol in a first time and frequency slot, and scheduling the transmitter to transmit, via the first transmission channel, the other one of the first symbol and the first orthogonal spread symbol in a second time and frequency slot; and
scheduling the transmitter to transmit, via a second transmission channel, either one of the second symbol and the second orthogonal spread symbol in the first time and frequency slot, and scheduling the transmitter to transmit, via the second transmission channel, the other one of the second symbol and the second orthogonal spread symbol in the second time and frequency slot.

31. The method of claim 30, with the orthogonal spread matrix being either one of a Fourier matrix and a Hadamard matrix.

32. The method of claim 31, with each element of the Fourier matrix being established by:
$${P}_{mn} = {e}^{j2π \frac{m}{N} ( n + \frac{g}{G} )} , where m , n = 0 , 1 , ⋯ ( N - 1 ) and$$
where N is the dimension of the Fourier matrix, G is the total number of matrices generated, m is the row number of the element, n is the column number of the element, and g is selected to be any number between 0 and G−1.

33. The method of claim 30, with the receiver transmitting control messages to the transmitter, the control message including which orthogonal spread matrix to use and which column of the orthogonal spread matrix to use for respectively generating the first and second orthogonal spread symbols.

34. The method of claim 30, with:
an identification number for the first transmission channel determines which column of the orthogonal spread matrix to use for generating the first orthogonal spread symbol; and
an identification number for the second transmission channel determines which column of the orthogonal spread matrix to use for generating the second orthogonal spread symbol.

35. The method of claim 30, when the receiver receives the symbols transmitted by the transmitter, with the receiver demodulating the received symbols by using the orthogonal spread matrix.

36. A communication network, comprising:
a receiver disposed to communicate with a transmitter by scheduling transmissions of N original symbols via N transmission channels to receiver in common time and frequency slots, with:
the transmitter orthogonally spreading the N original symbols based on an orthogonal spread matrix for generating N−1 orthogonal spread symbols for each of the N original symbols; and
the transmitter sequentially transmitting, via each of the N transmission channels, one of the N original symbol and the corresponding N−1 orthogonal spread symbols in N time and frequency slot, the order of the symbols to be transmitted is not restricted.

37. A communication network, comprising:
a receiver station disposed to scheduling a transmitter to transmit N original symbols via N transmission channels in common time and frequency slots to the receiver, with:
the transmitter orthogonally spreading the N original symbols based on a plurality of 2×2 orthogonal spread matrices for generating N−1 orthogonal spread symbols for each of the N original symbols, with each 2×2 orthogonal spread matrix being used for two symbols selected from the N original symbols; and
the transmitter sequentially transmitting, via each of the N transmission channels, one of the N original symbol and the corresponding N−1 orthogonal spread symbols in N time and frequency slot, the order of the symbols to be transmitted is not restricted.
